(19) United States
(12) Patent Application Publication
(10) Pub. No.: US 2026/0177810 A1
(43) Pub. Date: Jun. 25, 2026

(54) MIRROR DEVICE AND OPTICAL SCANNING DEVICE

(71) Applicant: FUJIFILM Corporation, Tokyo (JP)

(72) Inventors: Keisuke Aoshima, Kanagawa (JP); Hirotoshi Yoshizawa, Kanagawa (JP); Takayuki Naono, Kanagawa (JP)

(73) Assignee: FUJIFILM Corporation, Tokyo (JP)

(21) Appl. No.: 19/538,582

(22) Filed: Feb. 12, 2026

Related U.S. Application Data
(63) Continuation of application No. PCT/JP2024/026052, filed on Jul. 19, 2024.

(30) Foreign Application Priority Data
Aug. 16, 2023 (JP) 2023-132663

(51) Int. Cl. G02B 26/08; G02B 26/10

(52) U.S. Cl. CPC G02B 26/0841; G02B 26/0833; G02B 26/105

(57) ABSTRACT

A mirror device includes a mirror portion, a pair of first support portions, a pair of movable frames, a pair of second support portions, a drive portion having a plurality of piezoelectric actuators, a fixed frame, a pair of connecting portions connecting the drive portion and the fixed frame, and a piezoelectric sensor that generates a signal corresponding to swing of the mirror portion around the first axis or the second axis. The piezoelectric sensor is electrically isolated from the plurality of piezoelectric actuators. The plurality of piezoelectric actuators and the piezoelectric sensor are each formed of an upper electrode, a piezoelectric film, and a lower electrode. The upper electrodes of the plurality of piezoelectric actuators are connected in common via a first metal wire. The lower electrode of the piezoelectric sensor is connected to a second metal wire that is electrically isolated from the first metal wire.

### CROSS-REFERENCE TO RELATED APPLICATIONS

This application is a continuation application of International Application No. PCT/JP2024/026052, filed Jul. 19, 2024, the disclosure of which is incorporated herein by reference in its entirety. Further, this application claims priority from Japanese Patent Application No. 2023-132663, filed on Aug. 16, 2023, the disclosure of which is incorporated herein by reference in its entirety.

### BACKGROUND

### 1. Technical Field

The technology of the present disclosure relates to a mirror device and an optical scanning device.

### 2. Description of the Related Art

A micromirror device (also referred to as a microscanner) is known as one of micro electro mechanical systems (MEMS) devices manufactured using the silicon (Si) microfabrication technique. Since the micromirror device is small and has low power consumption, it is expected to be used in a wide range of applications including a laser display, a laser projector, an optical coherence tomography, and the like.

There are various drive methods for the micromirror device, and a piezoelectric drive method using deformation of a piezoelectric body is promising since the generated torque is higher than that in other methods and a high scan angle can be obtained. In particular, in a case where a high scan angle is required, such as in a laser display, a higher scan angle can be obtained by resonantly driving the micromirror device of the piezoelectric drive method.

A general micromirror device used in a laser display comprises a mirror portion and a drive portion having a plurality of piezoelectric actuators (see, for example, WO2022/025012A). The mirror portion is swingable around a first axis and a second axis that are orthogonal to each other. The drive portion causes the mirror portion to swing around the first axis and the second axis according to a drive voltage supplied from an outside.

In a biaxial micromirror device, it is essential to provide an angle sensor in order to detect an angle of a mirror portion around each axis in real time during biaxial driving. In a micromirror device using a piezoelectric actuator, a piezoelectric sensor is used as the angle sensor.

In addition, the micromirror device is provided with a fixed frame that surrounds the mirror portion and the drive portion, and a plurality of metal pads are provided on the fixed frame. The drive portion and the piezoelectric sensor are connected to each other through a metal pad and a metal wire.

### SUMMARY

However, in the micromirror device in the related art, since the piezoelectric sensor is commonly connected to a plurality of piezoelectric actuators and a metal wire for applying a ground potential, ringing noise generated in the drive portion may be transmitted to the piezoelectric sensor via the metal wire. Therefore, angle detection accuracy of the mirror portion may be reduced due to the ringing noise generated in the drive portion.

An object of the technology of the present disclosure is to provide a mirror device and an optical scanning device capable of improving angle detection accuracy of a mirror portion.

In order to achieve the above object, a mirror device of the present disclosure comprises: a mirror portion that reflects an incident ray; a pair of first support portions that are connected to the mirror portion on a first axis and that swingably support the mirror portion around the first axis; a pair of movable frames that are connected to the pair of first support portions and that face each other across the first axis; a pair of second support portions that are connected to the pair of movable frames on a second axis intersecting the first axis and that swingably support the mirror portion, the pair of first support portions, and the pair of movable frames around the second axis; a drive portion that surrounds the pair of movable frames and that has a plurality of piezoelectric actuators facing each other across the first axis or the second axis; a fixed frame that surrounds the drive portion; a pair of connecting portions that have a thinner thickness than the fixed frame and that stretch along the first axis or the second axis to connect the drive portion and the fixed frame; and a piezoelectric sensor that generates a signal corresponding to swing of the mirror portion around the first axis or the second axis, in which the piezoelectric sensor is electrically isolated from the plurality of piezoelectric actuators, the plurality of piezoelectric actuators and the piezoelectric sensor are each formed of an upper electrode, a piezoelectric film, and a lower electrode, the upper electrodes of the plurality of piezoelectric actuators are connected in common via a first metal wire, and the lower electrode of the piezoelectric sensor is connected to a second metal wire that is electrically isolated from the first metal wire.

It is preferable that the upper electrode of the piezoelectric sensor be connected to a third metal wire that is electrically isolated from the first metal wire.

It is preferable that the first metal wire be connected to a first metal pad for applying a ground potential, and the second metal wire be connected to a second metal pad for applying a ground potential.

It is preferable that the pair of connecting portions be disposed on the second axis.

An optical scanning device of the present disclosure comprises: the above mirror device; and a processor that drives the drive portion, in which the processor causes the mirror portion to swing around the first axis and the second axis by applying a drive signal to the lower electrode of each of the plurality of piezoelectric actuators.

It is preferable that the drive signal be a positive voltage.

According to the technology of the present disclosure, it is possible to provide a mirror device and an optical scanning device capable of improving angle detection accuracy of a mirror portion.

### BRIEF DESCRIPTION OF THE DRAWINGS

Exemplary embodiments according to the technique of the present disclosure will be described in detail based on the following figures, wherein:

FIG. 1 is a schematic diagram of an optical scanning device,

FIG. 2 is a block diagram showing an example of a hardware configuration of a drive control unit,

FIG. 3 is an external perspective view of a micromirror device,

FIG. 4 is a plan view of the micromirror device as viewed from a light incident side,

FIG. 5 is a cross-sectional view taken along a line A-A of FIG. 4,

FIG. 6 is a cross-sectional view showing a state in which a mirror portion is rotated around a first axis,

FIG. 7 is a diagram showing examples of a first drive signal and a second drive signal,

FIG. 8 is a cross-sectional view schematically showing a configuration of a piezoelectric sensor,

FIG. 9 is a cross-sectional view schematically showing configurations of a first actuator and a second actuator,

FIG. 10 is a plan view showing an example of a layout of metal pads and metal wires provided in the micromirror device,

FIG. 11 is a diagram schematically showing a connection relationship of the metal wires shown in FIG. 10, and

FIG. 12 is a diagram showing an example of signal processing of generating an angle detection signal.

### DETAILED DESCRIPTION

An example of an embodiment according to the technology of the present disclosure will be described with reference to the accompanying drawings.

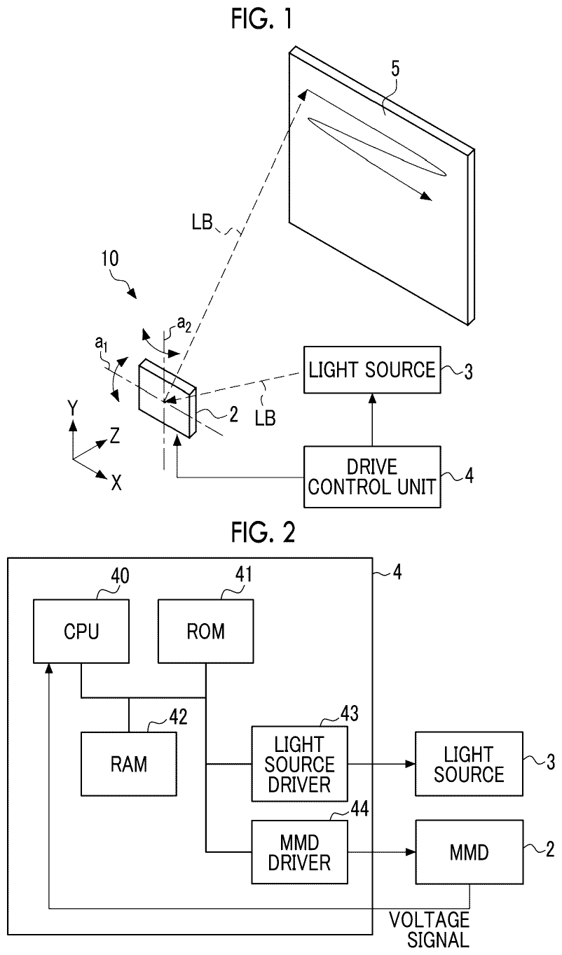

FIG. 1 schematically shows an optical scanning device 10 according to an embodiment. The optical scanning device 10 includes a micromirror device (hereinafter, referred to as micromirror device (MMD)) 2, a light source 3, and a drive control unit 4. The optical scanning device 10 optically scans a surface to be scanned 5 by reflecting a light beam LB emitted from the light source 3 by the MMD 2 under the control of the drive control unit 4. The surface to be scanned 5 is a screen, a retina of a human eye, or the like.

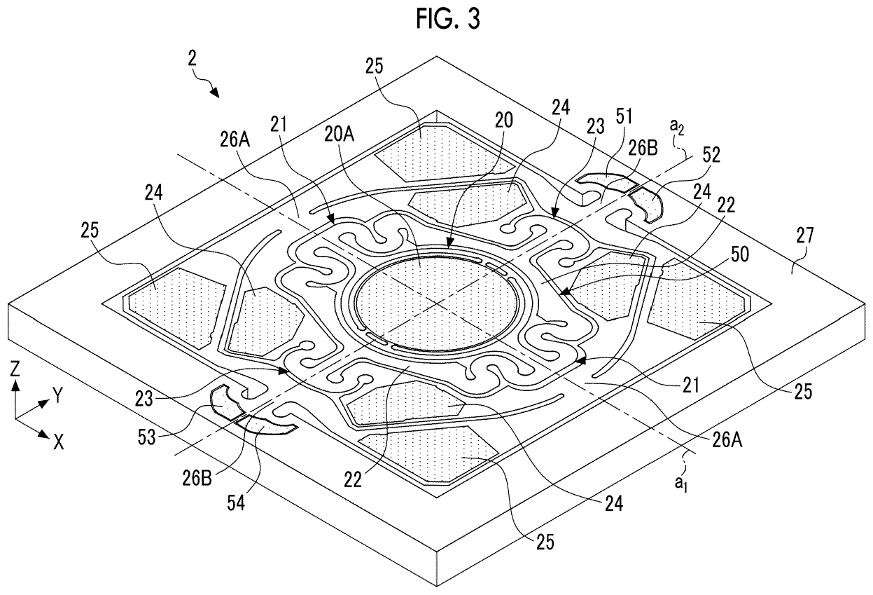

The MMD 2 is a piezoelectric biaxial drive type micromirror device capable of causing a mirror portion 20 (see FIG. 3) to swing around a first axis a₁ and around a second axis a₂ intersecting the first axis a₁. Hereinafter, a direction parallel to the first axis a₁ is referred to as an X direction, a direction parallel to the second axis a₂ is referred to as a Y direction, and a direction orthogonal to the first axis a₁ and the second axis a₂ is referred to as a Z direction. In the present embodiment, the X direction and the Y direction are orthogonal to each other. The MMD 2 is an example of a “mirror device” according to the technology of the present disclosure.

The light source 3 is a laser device that emits, for example, laser light as the light beam LB. The light source 3 may emit the light beam LB perpendicularly to a reflecting surface 20A (see FIG. 3) included in the mirror portion 20 in a state where the mirror portion 20 of the MMD 2 is stationary.

The drive control unit 4 outputs a drive signal to the light source 3 and the MMD 2 based on optical scanning information. The light source 3 generates the light beam LB and irradiates the MMD 2 with the light beam LB based on the input drive signal. The MMD 2 causes the mirror portion 20 to swing around the first axis a₁ and the second axis a₂ based on the input drive signal.

As will be described in detail below, the drive control unit 4 causes the mirror portion 20 to resonate around the first axis a₁ and the second axis a₂, so that the surface to be scanned 5 is scanned with the light beam LB reflected by the mirror portion 20 to form a Lissajous waveform. This optical scanning method is called a Lissajous scanning method.

The optical scanning device 10 is applied to, for example, a Lissajous scanning type laser display. Specifically, the optical scanning device 10 is applicable to a laser scanning display such as augmented reality (AR) glasses or virtual reality (VR) glasses.

FIG. 2 shows an example of a hardware configuration of the drive control unit 4. The drive control unit 4 includes a central processing unit (CPU) 40, a read only memory (ROM) 41, a random access memory (RAM) 42, a light source driver 43, and an MMD driver 44. The CPU 40 is a calculation device that implements the overall function of the drive control unit 4 by reading out a program and data from a storage device such as the ROM 41 into the RAM 42 and executing processing. The CPU 40 is an example of a processor according to the technology of the present disclosure.

The ROM 41 is a non-volatile storage device and stores a program for the CPU 40 to execute processing and data such as the above-described optical scanning information. The RAM 42 is a volatile storage device that temporarily holds a program and data.

The light source driver 43 is an electric circuit that outputs a drive signal to the light source 3 under the control of the CPU 40. In the light source driver 43, the drive signal is a drive voltage for controlling the irradiation timing and the irradiation intensity of the light source 3.

The MMD driver 44 is an electric circuit that outputs a drive signal to the MMD 2 under the control of the CPU 40. In the MMD driver 44, the drive signal is a drive voltage for controlling the timing, cycle, and deflection angle for allowing the mirror portion 20 of the MMD 2 to swing.

The CPU 40 controls the light source driver 43 and the MMD driver 44 based on the optical scanning information. The optical scanning information is information including the scanning pattern of the light beam LB with which the surface to be scanned 5 is scanned and the light emission timing of the light source 3.

In addition, the CPU 40 generates an angle detection signal representing an angle of the mirror portion 20 around the first axis a₁ and the second axis a₂ based on a voltage signal output from each of four piezoelectric sensors 51 to 54 described below that are provided in the MMD 2. The CPU 40 corrects the drive signal based on the generated angle detection signal.

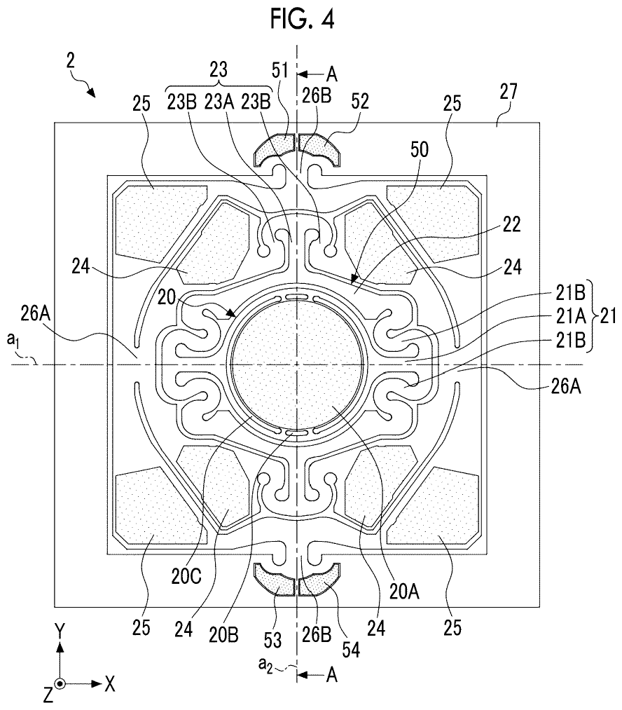

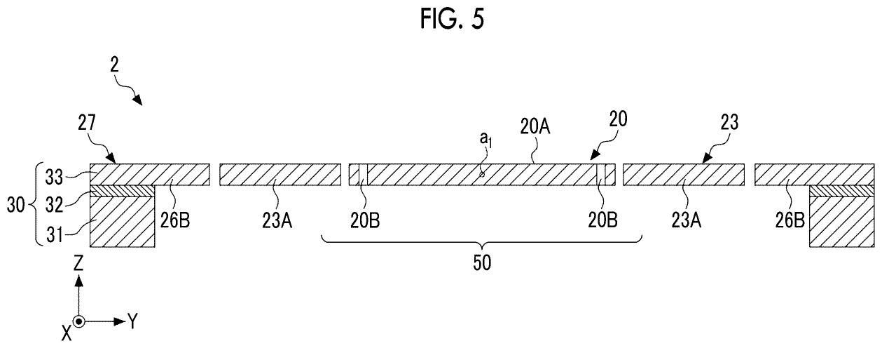

Next, a configuration of the MMD 2 will be described using FIGS. 3 to 5. FIG. 3 is an external perspective view of the MMD 2. FIG. 4 is a plan view of the MMD 2 as viewed from a light incident side. FIG. 5 is a cross-sectional view taken along a line A-A of FIG. 4.

As shown in FIG. 3, the MMD 2 has the mirror portion 20, a pair of first support portions 21, a pair of movable frames 22, a pair of second support portions 23, a first actuator 24, a second actuator 25, a pair of first connecting portions 26A, a pair of second connecting portions 26B, and a fixed frame 27. The MMD 2 is a so-called MEMS scanner.

The mirror portion 20 has a reflecting surface 20A that reflects an incident ray. The reflecting surface 20A is formed of a metal thin film, such as gold (Au) and aluminum (Al), provided on one surface of the mirror portion 20. The shape of the reflecting surface 20A is, for example, a circular shape centered on an intersection between the first axis a₁ and the second axis a₂.

The first axis a₁ and the second axis a₂ exist, for example, in a plane including the reflecting surface 20A in a case where the mirror portion 20 is stationary. The planar shape of the MMD 2 is rectangular, and is line-symmetric about the first axis a₁ and line-symmetric about the second axis a₂.

The pair of first support portions 21 are disposed at positions facing each other across the second axis a₂, and have a line-symmetric shape about the second axis a₂. In addition, each of the first support portions 21 has a line-symmetric shape about the first axis a₁. Each of the first support portions 21 is connected to the mirror portion 20 on the first axis a₁, and swingably supports the mirror portion 20 around the first axis a₁.

The pair of movable frames 22 are disposed at positions facing each other across the first axis a₁, and have a line-symmetric shape about the first axis a₁. Each of the movable frames 22 has a line-symmetric shape about the second axis a₂. In addition, each of the movable frames 22 is curved along the outer periphery of the mirror portion 20. Both ends of each of the movable frames 22 are connected to the pair of first support portions 21.

The pair of first support portions 21 and the pair of movable frames 22 are connected to each other, thereby surrounding the mirror portion 20. The mirror portion 20, the pair of first support portions 21, and the pair of movable frames 22 constitute a movable portion 50.

The pair of second support portions 23 are disposed at positions facing each other across the first axis a₁, and have a line-symmetric shape about the first axis a₁. Each of the second support portions 23 has a line-symmetric shape about the second axis a₂. Each of the second support portions 23 is connected to the movable frame 22 on the second axis a₂, and swingably supports the movable portion 50 having the mirror portion 20 around the second axis a₂. In addition, both ends of each of the second support portions 23 are connected to the first actuator 24.

The first actuator 24 is composed of a pair of piezoelectric actuators facing each other across the second axis a₂, and has a line-symmetric shape about the second axis a₂. In addition, the first actuator 24 has a line-symmetric shape about the first axis a₁. The first actuator 24 is disposed along the outer periphery of the pair of movable frames 22 and the pair of first support portions 21.

In FIGS. 3 and 4, the piezoelectric actuators constituting the first actuator 24 appear to be separated across the first axis a₁, but two piezoelectric actuators facing each other across the first axis a₁ are electrically connected to each other via a metal wire (not shown).

The pair of second support portions 23 and the first actuator 24 are connected to each other, thereby surrounding the movable portion 50.

The second actuator 25 is composed of a pair of piezoelectric actuators facing each other across the first axis a₁, and has a line-symmetric shape about the first axis a₁. In addition, the second actuator 25 has a line-symmetric shape about the second axis a₂. The second actuator 25 is disposed along the outer periphery of the first actuator 24 and the pair of second support portions 23.

In FIGS. 3 and 4, the piezoelectric actuators constituting the second actuator 25 appear to be separated across the second axis a₂, but two piezoelectric actuators facing each other across the second axis a₂ are electrically connected to each other via a metal wire (not shown).

The pair of first connecting portions 26A are disposed at positions facing each other across the second axis a₂, and have a line-symmetric shape about the second axis a₂. In addition, each of the first connecting portions 26A has a line-symmetric shape about the first axis a₁. Each of the first connecting portions 26A is disposed along the first axis a₁ and connects the first actuator 24 and the second actuator 25 on the first axis a₁.

The pair of second connecting portions 26B are disposed at positions facing each other across the first axis a₁, and have a line-symmetric shape about the first axis a₁. In addition, each of the second connecting portions 26B extends in the Y direction and has a line-symmetric shape about the second axis a₂. Each of the second connecting portion 26B is disposed along the second axis a₂, and connects the second actuator 25 and the fixed frame 27 on the second axis a₂. The pair of second connecting portions 26B are examples of “a pair of connecting portions” according to the technology of the present disclosure.

The second actuator 25 and the pair of second connecting portions 26B are connected to each other, thereby surrounding the movable portion 50 and the first actuator 24. The first actuator 24 and the second actuator 25 constitute a drive portion surrounding the pair of movable frames 22. That is, the drive portion has a plurality of piezoelectric actuators facing each other across the first axis a₁ or the second axis a₂.

The fixed frame 27 is a frame-shaped member having a rectangular outer shape, and has a line-symmetric shape about each of the first axis a₁ and the second axis a₂. The fixed frame 27 surrounds the outer periphery of the second actuator 25 and the pair of second connecting portions 26B. That is, the fixed frame 27 surrounds the drive portion.

The first actuator 24 causes the movable portion 50 to swing around the second axis a₂ by applying a rotational torque around the second axis a₂ to the mirror portion 20 and the pair of movable frames 22. The second actuator 25 causes the mirror portion 20 to swing around the first axis a₁ by applying a rotational torque around the first axis a₁ to the mirror portion 20, the pair of movable frames 22, and the first actuator 24.

As shown in FIG. 4, each of the first support portions 21 is composed of a swing shaft 21A and a pair of coupling portions 21B. The swing shaft 21A is a so-called torsion bar that extends along the first axis a₁. One end of the swing shaft 21A is connected to the mirror portion 20, and the other end is connected to the pair of coupling portions 21B.

The pair of coupling portions 21B are disposed at positions facing each other across the first axis a₁, and have a line-symmetric shape about the first axis a₁. One end of each of the coupling portions 21B is connected to the swing shaft 21A, and the other end is connected to the movable frame 22. Each of the coupling portions 21B has a folded-back structure. Since each of the coupling portions 21B has elasticity due to the folded-back structure, the internal stress applied to the swing shaft 21A is relaxed in a case where the mirror portion 20 swings around the first axis a₁.

Each of the second support portions 23 is composed of a swing shaft 23A and a pair of coupling portions 23B. The swing shaft 23A is a so-called torsion bar that extends along the second axis a₂. One end of the swing shaft 23A is connected to the movable frame 22, and the other end is connected to the pair of coupling portions 23B.

The pair of coupling portions 23B are disposed at positions facing each other across the second axis a₂ and have a line-symmetric shape about the second axis a₂. One end of each of the coupling portions 23B is connected to the swing shaft 23A, and the other end is connected to the first actuator 24. Each of the coupling portions 23B has a folded-back structure. Since each of the coupling portions 23B has elasticity due to the folded-back structure, the internal stress applied to the swing shaft 23A is relaxed in a case where the mirror portion 20 swings around the second axis a₂.

In addition, in the mirror portion 20, a plurality of slits 20B and 20C are formed on the outside of the reflecting surface 20A along the outer periphery of the reflecting surface 20A. The plurality of slits 20B and 20C are disposed at positions that are line-symmetric about the first axis a₁ and the second axis a₂, respectively. The slits 20B and 20C have an effect of suppressing distortion generated on the reflecting surface 20A due to the swing of the mirror portion 20.

Four piezoelectric sensors 51 to 54 are provided in the vicinity of the pair of second connecting portions 26B as angle sensors for detecting an angle of the mirror portion 20. The piezoelectric sensors 51 to 54 are formed of a piezoelectric element, as with the first actuator 24 and the second actuator 25. The piezoelectric sensors 51 to 54 are in a line-symmetric relationship about each of the first axis a₁ and the second axis a₂. Specifically, the piezoelectric sensors 51 and 52 are disposed in the vicinity of one of the pair of second connecting portions 26B, and are in a line-symmetric relationship about the second axis a₂ in terms of position and shape. The piezoelectric sensors 53 and 54 are disposed in the vicinity of the other of the pair of second connecting portions 26B, and are in a line-symmetric relationship about the second axis a₂ in terms of position and shape. The piezoelectric sensors 51 and 52 and the piezoelectric sensors 53 and 54 are in a line-symmetric relationship about the first axis a₁ in terms of position and shape.

In FIGS. 3 and 4, a metal wire and a metal pad for applying the drive signal to the first actuator 24 and the second actuator 25 are not shown. In addition, a metal wire and a metal pad for acquiring the voltage signals output from the piezoelectric sensors 51 to 54 are not shown. A plurality of metal pads are provided on the fixed frame 27. The metal pad is also referred to as an electrode pad.

As shown in FIG. 5, the MMD 2 is formed by, for example, etching a silicon on insulator (SOI) substrate 30. The SOI substrate 30 is a substrate in which a silicon oxide layer 32 is provided on a silicon support layer 31 consisting of single crystal silicon, and a silicon active layer 33 consisting of single crystal silicon is provided on the silicon oxide layer 32.

The mirror portion 20, the pair of first support portions 21, the pair of movable frames 22, the pair of second support portions 23, the first actuator 24, the second actuator 25, the pair of first connecting portions 26A, and the pair of second connecting portions 26B are formed from the silicon active layer 33 that remains after removing the silicon support layer 31 and the silicon oxide layer 32 from the SOI substrate 30 by etching. The silicon active layer 33 functions as an elastic portion having elasticity. The fixed frame 27 is formed of three layers of the silicon support layer 31, the silicon oxide layer 32, and the silicon active layer 33. That is, the mirror portion 20, the pair of first support portions 21, the pair of movable frames 22, the pair of second support portions 23, the first actuator 24, the second actuator 25, the pair of first connecting portions 26A, and the pair of second connecting portions 26B are each thinner than the fixed frame 27. In the present disclosure, the thickness refers to a width in the Z direction.

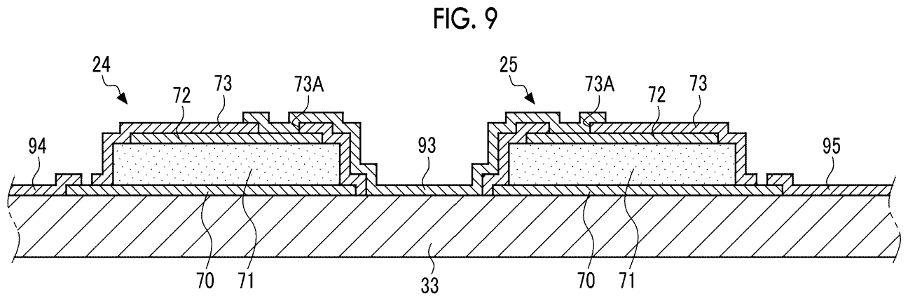

The piezoelectric actuator constituting the first actuator 24 is composed of a piezoelectric element formed on the silicon active layer 33. The piezoelectric element has a laminated structure in which a lower electrode 70, a piezoelectric film 71, and an upper electrode 72 are laminated in this order on the silicon active layer 33 (see FIG. 9). The second actuator 25 has the same configuration as the first actuator 24.

The lower electrode 70 and the upper electrode 72 are electrically connected to the above-described drive control unit 4 via a wiring and an electrode pad. As will be described in detail below, the drive signal is applied to the lower electrode 70 from the drive control unit 4. The upper electrode 72 is connected to the drive control unit 4 via a wiring and an electrode pad, and a ground potential is applied thereto.

In a case where a positive or negative voltage is applied to the piezoelectric film 71 in a polarization direction, deformation (for example, expansion and contraction) proportional to the applied voltage occurs. That is, the piezoelectric film 71 exhibits a so-called inverse piezoelectric effect. The piezoelectric film exhibits the inverse piezoelectric effect by applying the drive signal from the drive control unit 4 to the lower electrode 70, and displaces the first actuator 24 and the second actuator 25.

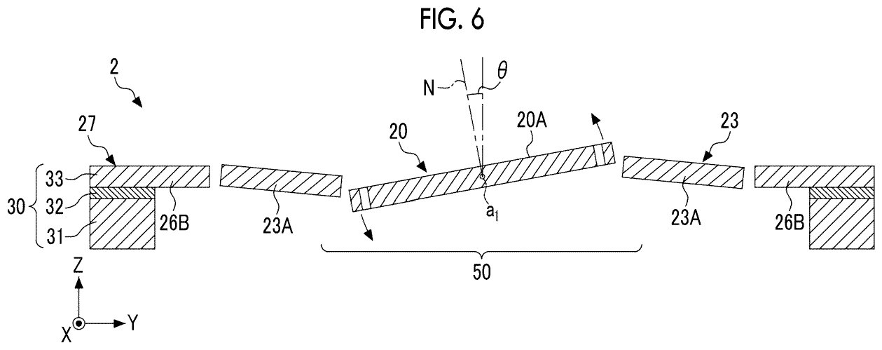

FIG. 6 shows an example in which one of the pair of piezoelectric actuators constituting the second actuator 25 is extended and the other is contracted, thereby causing the second actuator 25 to generate a rotational torque around the first axis a₁. In this way, one and the other of the pair of piezoelectric actuators are displaced in opposite directions, whereby the mirror portion 20 rotates around the first axis a₁.

In addition, FIG. 6 shows an example in which the second actuator 25 is driven in an anti-phase resonance mode (hereinafter, referred to as an anti-phase rotation mode) in which the displacement direction of the pair of piezoelectric actuators and the rotation direction of the mirror portion 20 are opposite to each other. On the other hand, an in-phase resonance mode in which the displacement direction of the pair of piezoelectric actuators and the rotation direction of the mirror portion 20 are the same direction is called an in-phase rotation mode. In the present embodiment, the second actuator 25 is driven in the anti-phase rotation mode.

A deflection angle θ of the mirror portion 20 around the first axis a₁ is controlled by the drive signal (hereinafter, referred to as a first drive signal) given to the second actuator 25 by the drive control unit 4. The first drive signal is, for example, a sinusoidal AC voltage. The first drive signal includes a drive voltage waveform V_{1A}(t) applied to one of the pair of piezoelectric actuators and a drive voltage waveform V_{1B}(t) applied to the other. The drive voltage waveform V_{1A}(t) and the drive voltage waveform V_{1B}(t) are in an anti-phase with each other (that is, a phase difference is) 180°.

A deflection angle θ of the mirror portion 20 around the first axis a₁ corresponds to an angle at which a normal line N of the reflecting surface 20A is inclined with respect to the Z direction in a YZ plane.

The first actuator 24 is driven in an anti-phase resonance mode in the same manner as the second actuator 25. A deflection angle of the mirror portion 20 around the second axis a₂ is controlled by the drive signal (hereinafter, referred to as a second drive signal) given to the first actuator 24 by the drive control unit 4. The second drive signal is, for example, a sinusoidal AC voltage. The second drive signal includes a drive voltage waveform V_{2A}(t) applied to one of the pair of piezoelectric actuators and a drive voltage waveform V_{2B}(t) applied to the other. The drive voltage waveform V_{2A}(t) and the drive voltage waveform V_{2B}(t) are in an anti-phase with each other (that is, a phase difference is) 180°.

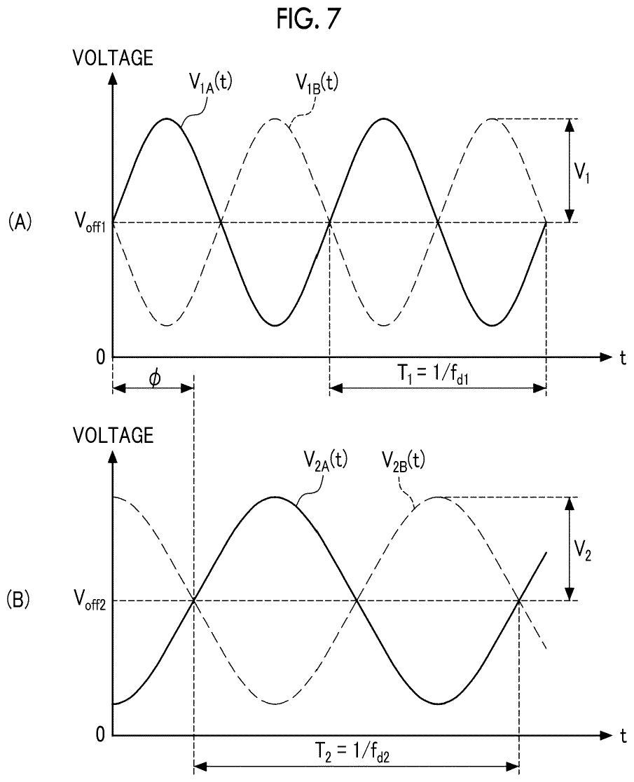

FIG. 7 shows examples of the first drive signal and the second drive signal. (A) of FIG. 7 shows the drive voltage waveforms V_{1A}(t) and V_{1B}(t) included in the first drive signal. (B) of FIG. 7 shows the drive voltage waveforms V_{2A}(t) and V_{2B}(t) included in the second drive signal.

The drive voltage waveforms V_{1A}(t) and V_{1B}(t) are represented as follows, respectively.

V_{1A}(t)=V_{off1}+V₁ sin(2πf_{d1}t)

V_{1B}(t)=V_{off1}+V₁ sin(2πf_{d1}t+α)

Here, V₁ is an amplitude voltage. V_{off1} is a bias voltage. f_{d1} is a driving frequency (hereinafter, referred to as a first driving frequency). t is time. α is a phase difference between the drive voltage waveforms V_{1A}(t) and V_{1B}(t). In the present embodiment, for example, α=180°.

By applying the drive voltage waveforms V_{1A}(t) and V_{1B}(t) to the second actuator 25, the mirror portion 20 swings around the first axis a₁ at the first driving frequency f_{d1}.

The drive voltage waveforms V_{2A}(t) and V_{2B}(t) are represented as follows, respectively.

V_{2A}(t)=V_{off2}+V₂ sin(2πf_{d2}t+φ)

V_{2B}(t)=V_{off2}e+V₂ sin(2πf_{d2}t+β+φ)

Here, V₂ is an amplitude voltage. V_{off2} is a bias voltage. f_{d2} is a driving frequency (hereinafter, referred to as a second driving frequency). t is time. β is a phase difference between the drive voltage waveforms V_{2A}(t) and V_{2B}(t). In the present embodiment, for example, β=180°. In addition, φ is a phase difference between the drive voltage waveforms V_{1A}(t) and V_{1B}(t) and the drive voltage waveforms V_{2A}(t) and V_{2B}(t).

In the present embodiment, V_{off1}≥V₁ and V_{off2}≥V₂. That is, the first drive signal and the second drive signal are set to positive voltages.

By applying the drive voltage waveforms V_{2A}(t) and V_{2B}(t) to the first actuator 24, the movable portion 50 including the mirror portion 20 swings around the second axis a₂ at the second driving frequency f_{d2}.

The first driving frequency f_{d1} is set to match a resonance frequency of the mirror portion 20 around the first axis a₁. The second driving frequency f_{d2} is set to match a resonance frequency of the mirror portion 20 around the second axis a₂. In the present embodiment, the first driving frequency f_{d1} is higher than the second driving frequency f_{d2}.

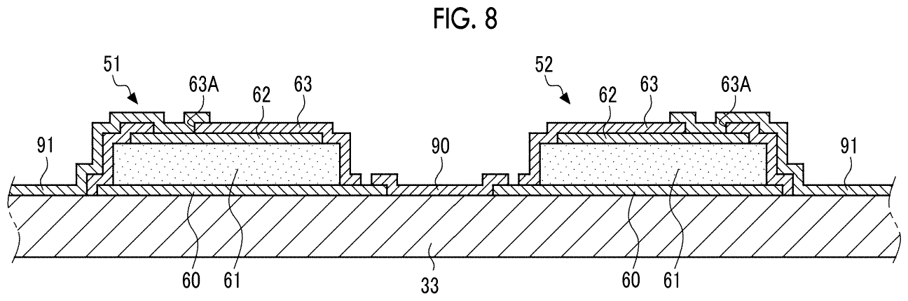

FIG. 8 schematically shows a configuration of the piezoelectric sensors 51 and 52. Each of the piezoelectric sensors 51 and 52 includes a lower electrode 60, a piezoelectric film 61, and an upper electrode 62. The lower electrode 60, the piezoelectric film 61, and the upper electrode 62 are laminated in this order on the silicon active layer 33. The lower electrode 60 and the upper electrode 62 are formed of, for example, a metal such as gold (Au) or platinum (Pt). The piezoelectric film 61 is formed of, for example, lead zirconate titanate (PZT) that is a piezoelectric material.

The upper electrode 62 is covered with an insulating film 63. The insulating film 63 has an opening 63A that exposes a part of the upper electrode 62. A metal wire 91 formed of a metal is provided on the insulating film 63. The metal wire 91 is connected to the upper electrode 62 via the opening 63A. The lower electrode 60 is connected to a metal wire 90 formed on the silicon active layer 33. The lower electrode 60 of the piezoelectric sensor 51 and the lower electrode 60 of the piezoelectric sensor 52 are connected to each other via the metal wire 90. A ground potential is applied to the metal wire 90.

The piezoelectric film 61 converts a stress applied in a case where the mirror portion 20 swings into a voltage signal through a piezoelectric effect. As a result, the voltage signal corresponding to the angle of the mirror portion 20 is acquired from the upper electrode 62.

The piezoelectric sensors 53 and 54 have the same configuration as the piezoelectric sensors 51 and 52.

FIG. 9 schematically shows a configuration of the first actuator 24 and the second actuator 25. The piezoelectric actuator constituting the first actuator 24 and the second actuator 25 includes a lower electrode 70, a piezoelectric film 71, and an upper electrode 72. The lower electrode 70, the piezoelectric film 71, and the upper electrode 72 are laminated in this order on the silicon active layer 33. The lower electrode 70 and the upper electrode 72 are formed of, for example, a metal such as gold (Au) or platinum (Pt). The piezoelectric film 71 is formed of, for example, lead zirconate titanate (PZT) that is a piezoelectric material.

The upper electrode 72 is covered with an insulating film 73. The insulating film 73 has an opening 73A that exposes a part of the upper electrode 72. A metal wire 93 formed of a metal is provided on the insulating film 73. The metal wire 93 is connected to the upper electrode 72 via the opening 73A. The upper electrode 72 of the piezoelectric actuator constituting the first actuator 24 and the upper electrode 72 of the piezoelectric actuator constituting the second actuator 25 are connected to each other via the metal wire 93. A ground potential is applied to the metal wire 93.

In addition, the lower electrode 70 of the piezoelectric actuator constituting the first actuator 24 is connected to a metal wire 94 formed on the silicon active layer 33. The lower electrode 70 of the piezoelectric actuator constituting the second actuator 25 is connected to a metal wire 95 formed on the silicon active layer 33.

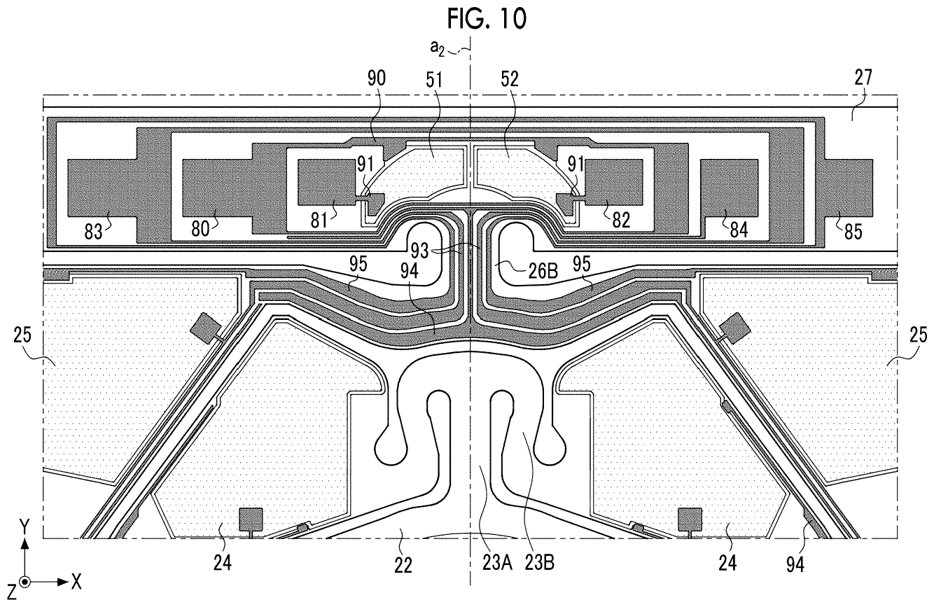

FIG. 10 shows an example of a layout of the metal pads and the metal wires provided in the MMD 2. FIG. 10 is a partially enlarged view of a region including the piezoelectric sensors 51 and 52.

A plurality of metal pads 80 to 85 are formed on the fixed frame 27. The metal pad 80 is an electrode pad for applying a ground potential to the piezoelectric sensors 51 and 52, and is connected to the metal wire 90. As described above, the metal wire 90 is commonly connected to the lower electrode 60 of the piezoelectric sensor 51 and the lower electrode 60 of the piezoelectric sensor 52.

The metal pad 81 is an electrode pad for acquiring the voltage signal from the piezoelectric sensor 51, and is connected to the metal wire 91 that is connected to the upper electrode 62 of the piezoelectric sensor 51. Similarly, the metal pad 82 is an electrode pad for acquiring the voltage signal from the piezoelectric sensor 52, and is connected to the metal wire 91 that is connected to the upper electrode 62 of the piezoelectric sensor 52.

The metal pad 83 is an electrode pad for applying a ground potential to the first actuator 24 and the second actuator 25, and is connected to the metal wire 93. As described above, the metal wire 93 is commonly connected to the upper electrode 72 of the piezoelectric actuator constituting the first actuator 24 and the upper electrode 72 of the piezoelectric actuator constituting the second actuator 25.

The metal pad 84 is an electrode pad for applying the second drive signal to the first actuator 24, and is connected to the metal wire 94. The metal wire 94 is connected to the lower electrode 70 of the piezoelectric actuator constituting the first actuator 24.

The metal pad 85 is an electrode pad for applying the first drive signal to the second actuator 25, and is connected to the metal wire 95. The metal wire 95 is connected to the lower electrode 70 of the piezoelectric actuator constituting the second actuator 25.

The metal wires 93 to 95 are wired from the fixed frame 27 through the second connecting portion 26B to a formation region of the second actuator 25. In addition, although not shown in FIG. 10, the metal wires 93 and 94 are further wired from the second actuator 25 through the first connecting portion 26A to a formation region of the first actuator 24.

Although not shown, the layout of the plurality of metal pads and the plurality of metal wires in a region including the piezoelectric sensors 53 and 54 is the same as that in FIG. 10. In the present embodiment, the plurality of metal pads and the plurality of metal wires are formed with 180° rotational symmetry about the intersection between the first axis a₁ and the second axis a₂.

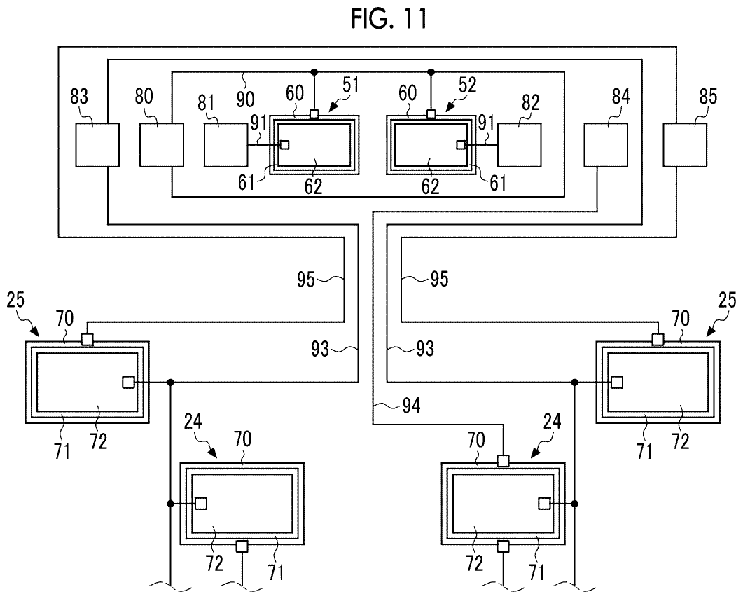

FIG. 11 is a diagram schematically showing a connection relationship of the metal wires shown in FIG. 10. As shown in FIG. 11, the piezoelectric sensors 51 and 52 are applied with a ground potential from the metal pad 80 via the metal wire 90, the first actuator 24 and the second actuator 25 are applied with a ground potential from the metal pad 83 via the metal wire 93, and the metal wire 90 and the metal wire 93 are electrically isolated from each other. Therefore, the piezoelectric sensors 51 and 52 are electrically isolated from the first actuator 24 and the second actuator 25. Similarly, the piezoelectric sensors 53 and 54 are electrically isolated from the first actuator 24 and the second actuator 25.

In addition, the upper electrodes 72 of the plurality of piezoelectric actuators constituting the first actuator 24 and the second actuator 25 are connected in common via the metal wire 93. The metal wire 93 is an example of a “first metal wire” according to the technology of the present disclosure. In addition, the metal pad 83 is an example of a “first metal pad” according to the technology of the present disclosure.

The lower electrode 60 of each of the piezoelectric sensors 51 and 52 is connected to the metal wire 90 that is electrically isolated from the metal wire 93. The metal wire 90 is an example of a “second metal wire” according to the technology of the present disclosure. In addition, the metal pad 80 is an example of a “second metal pad” according to the technology of the present disclosure.

In addition, the upper electrode 62 of each of the piezoelectric sensors 51 and 52 is connected to the metal wire 91 that is electrically isolated from the metal wire 93. The metal wire 91 is an example of a “third metal wire” according to the technology of the present disclosure. The same applies to the piezoelectric sensors 53 and 54.

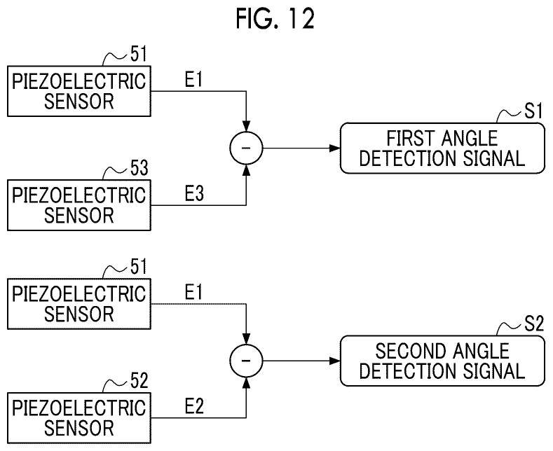

FIG. 12 shows an example of signal processing of generating an angle detection signal by means of the CPU 40. For example, the CPU 40 generates a first angle detection signal S1 representing an angle of the mirror portion 20 around the first axis a₁ by subtracting a voltage signal E3 obtained from the upper electrode 62 of the piezoelectric sensor 53 from a voltage signal E1 obtained from the upper electrode 62 of the piezoelectric sensor 51. In addition, the CPU 40 generates a second angle detection signal S2 representing an angle of the mirror portion 20 around the second axis a₂ by subtracting a voltage signal E2 obtained from the upper electrode 62 of the piezoelectric sensor 52 from the voltage signal E1 obtained from the upper electrode 62 of the piezoelectric sensor 51.

Signal components (detection target components) around the first axis a₁ included in the voltage signal E1 and the voltage signal E3 are in an anti-phase with each other. On the other hand, signal components (noise components) around the second axis a₂ included in the voltage signal E1 and the voltage signal E3 are in-phase with each other. Therefore, by subtracting the voltage signal E3 from the voltage signal E1, the detection target component is amplified, and the other-axis noise, which is a signal component around the other axis other than the detection target, is reduced.

Signal components (detection target components) around the second axis a₂ included in the voltage signal E1 and the voltage signal E2 are in an anti-phase with each other. On the other hand, signal components (noise components) around the first axis a₁ included in the voltage signal E1 and the voltage signal E2 are in-phase with each other. Therefore, by subtracting the voltage signal E2 from the voltage signal E1, the detection target component is amplified, and the other-axis noise, which is a signal component around the other axis other than the detection target, is reduced.

As described above, in the MMD according to the technology of the present disclosure, since the piezoelectric sensor is electrically isolated from the plurality of piezoelectric actuators included in the drive portion, the ringing noise generated in the drive portion is prevented from being transmitted to the piezoelectric sensor via the metal wire. As a result, the angle detection accuracy of the mirror portion is improved.

In addition, a direction of spontaneous polarization of the piezoelectric film 71 of the piezoelectric actuator is determined by a thin film forming process, and the direction of the spontaneous polarization is from the lower electrode 70 to the upper electrode 72. In order to satisfactorily displace the piezoelectric film 71 through the inverse piezoelectric effect under such spontaneous polarization, it is necessary to apply a voltage in a direction opposite to the direction of the spontaneous polarization. In a case where a ground potential is applied to the lower electrode 70, it is necessary to set a drive signal applied to the upper electrode 72 to a negative voltage. In a case where the drive signal is set to a negative voltage in this way, there are few options for a circuit element for generating the negative voltage, and there are disadvantages such as an increase in power consumption. On the other hand, in the MMD according to the technology of the present disclosure, since a ground potential is applied to the upper electrode 72 and a drive signal is applied to the lower electrode 70, the drive signal can be set to a positive voltage. Therefore, according to the technology of the present disclosure, the options for the circuit element are expanded, making it possible to reduce power consumption.

The configuration of the MMD 2 according to the above-described embodiment is an example, and various modifications can be made.

In the above-described embodiment, as shown in FIG. 12, the first angle detection signal S1 is generated by subtracting the voltage signal E3 from the voltage signal E1, and the second angle detection signal S2 is generated by subtracting the voltage signal E2 from the voltage signal E1. Instead of this, the first angle detection signal S1 can be generated by adding the voltage signal E1 and the voltage signal E2, and the second angle detection signal S2 can be generated by subtracting the voltage signal E3 from the voltage signal E1. In this way, it is possible to generate the first angle detection signal S1 and the second angle detection signal S2 by adding or subtracting the voltage signals E1 to E4.

In addition, in the above-described embodiment, the lower electrode 60 of the piezoelectric sensor 51 and the lower electrode 60 of the piezoelectric sensor 52 are connected in common via the metal wire 90, but the upper electrode 62 of the piezoelectric sensor 51 and the upper electrode 62 of the piezoelectric sensor 52 may be connected in common via the metal wire 90. In this case, a ground potential is applied to the upper electrode 62, and a voltage signal for angle detection is acquired from the lower electrode 60. The same applies to the piezoelectric sensors 53 and 54.

In addition, in the above-described embodiment, four piezoelectric sensors 51 to 54 are provided, but the number of the piezoelectric sensors is not limited to four. For example, one piezoelectric sensor may be provided in the vicinity of the first axis a₁ and one piezoelectric sensor may be provided in the vicinity of the second axis a₂. In addition, the shape and arrangement position of the piezoelectric sensor can be changed as appropriate. For example, the piezoelectric sensor may be provided on the first axis a₁ or the second axis a₂.

In addition, in the above-described embodiment, the hardware configuration of the drive control unit 4 can be variously modified. A processing unit of the drive control unit 4 may be configured by one processor or may be configured by a combination of two or more processors of the same type or different types. The processor includes a CPU, a programmable logic device (PLD), a dedicated electric circuit, and the like. As is well known, the CPU is a general-purpose processor that executes software (program) to function as various processing units. The PLD is a processor of which a circuit configuration can be changed after manufacture, such as a field programmable gate array (FPGA). The dedicated electric circuit is a processor having a circuit configuration that is designed for a specific purpose to execute specific processing, such as an application specific integrated circuit (ASIC).

The following technology can be understood from the above description.

[Supplementary Note 1]

A mirror device comprising:
a mirror portion that reflects an incident ray;
a pair of first support portions that are connected to the mirror portion on a first axis and that swingably support the mirror portion around the first axis;
a pair of movable frames that are connected to the pair of first support portions and that face each other across the first axis;
a pair of second support portions that are connected to the pair of movable frames on a second axis intersecting the first axis and that swingably support the mirror portion, the pair of first support portions, and the pair of movable frames around the second axis;
a drive portion that surrounds the pair of movable frames and that has a plurality of piezoelectric actuators facing each other across the first axis or the second axis;
a fixed frame that surrounds the drive portion;
a pair of connecting portions that have a thinner thickness than the fixed frame and that stretch along the first axis or the second axis to connect the drive portion and the fixed frame; and
a piezoelectric sensor that generates a signal corresponding to swing of the mirror portion around the first axis or the second axis,
in which the piezoelectric sensor is electrically isolated from the plurality of piezoelectric actuators,
the plurality of piezoelectric actuators and the piezoelectric sensor are each formed of an upper electrode, a piezoelectric film, and a lower electrode,
the upper electrodes of the plurality of piezoelectric actuators are connected in common via a first metal wire, and
the lower electrode of the piezoelectric sensor is connected to a second metal wire that is electrically isolated from the first metal wire.

[Supplementary Note 2]

The mirror device according to Supplementary Note 1, in which the upper electrode of the piezoelectric sensor is connected to a third metal wire that is electrically isolated from the first metal wire.

[Supplementary Note 3]

The mirror device according to Supplementary Note 1 or 2,
in which the first metal wire is connected to a first metal pad for applying a ground potential, and
the second metal wire is connected to a second metal pad for applying a ground potential.

[Supplementary Note 4]

The mirror device according to any one of Supplementary Notes 1 to 3, in which the pair of connecting portions are disposed on the second axis.

[Supplementary Note 5]

An optical scanning device comprising:
the mirror device according to any one of Supplementary Notes 1 to 4; and
a processor that drives the drive portion,
in which the processor causes the mirror portion to swing around the first axis and the second axis by applying a drive signal to the lower electrode of each of the plurality of piezoelectric actuators.

[Supplementary Note 6]

The optical scanning device according to Supplementary Note 5,
in which the drive signal is a positive voltage.

What is claimed is:

1. A mirror device comprising:
a mirror portion that reflects an incident ray;
a pair of first support portions that are connected to the mirror portion on a first axis and that swingably support the mirror portion around the first axis;
a pair of movable frames that are connected to the pair of first support portions and that face each other across the first axis;
a pair of second support portions that are connected to the pair of movable frames on a second axis intersecting the first axis and that swingably support the mirror portion, the pair of first support portions, and the pair of movable frames around the second axis;
a drive portion that surrounds the pair of movable frames and that has a plurality of piezoelectric actuators facing each other across the first axis or the second axis;
a fixed frame that surrounds the drive portion;
a pair of connecting portions that have a thinner thickness than the fixed frame and that stretch along the first axis or the second axis to connect the drive portion and the fixed frame; and
a piezoelectric sensor that generates a signal corresponding to swing of the mirror portion around the first axis or the second axis,
wherein the piezoelectric sensor is electrically isolated from the plurality of piezoelectric actuators,
the plurality of piezoelectric actuators and the piezoelectric sensor are each formed of an upper electrode, a piezoelectric film, and a lower electrode,
the upper electrodes of the plurality of piezoelectric actuators are connected in common via a first metal wire, and
the lower electrode of the piezoelectric sensor is connected to a second metal wire that is electrically isolated from the first metal wire.

2. The mirror device according to claim 1,
wherein the upper electrode of the piezoelectric sensor is connected to a third metal wire that is electrically isolated from the first metal wire.

3. The mirror device according to claim 1,
wherein the first metal wire is connected to a first metal pad for applying a ground potential, and
the second metal wire is connected to a second metal pad for applying a ground potential.

4. The mirror device according to claim 1,
wherein the pair of connecting portions are disposed on the second axis.

5. An optical scanning device comprising:
the mirror device according to claim 1; and
a processor that drives the drive portion,
wherein the processor causes the mirror portion to swing around the first axis and the second axis by applying a drive signal to the lower electrode of each of the plurality of piezoelectric actuators.

6. The optical scanning device according to claim 5,
wherein the drive signal is a positive voltage.
